(19) United States
(12) Patent Application Publication
(10) Pub. No.: US 2001/0018871 A1
(43) Pub. Date: Sep. 6, 2001

(54) Transport system for a printing machine

(76) Inventor: Andreas Henn, Neckargemund (DE)

Correspondence Address: LERNER AND GREENBERG, P.A., Post Office Box 2480, Hollywood, FL, 33022-2480, US

(21) Appl. No.: 09/771,901

(22) Filed: Jan. 29, 2001

(30) Foreign Application Priority Data
Jan. 27, 2000 (DE) 100 03 352.0

(51) Int. Cl. B41L 9/10

(52) U.S. Cl. 101/132

(57) ABSTRACT

A printing-material transport system for a printing machine, having at least one printing-material guide surface and a device for producing an air cushion between the guide surface and the printing material, comprising at least one sensor arrangement for registering the spaced distance between the printing material and the guide surface, and a control device for controlling the thickness of the air cushion, based upon the registered distance, so that the spaced distance registered by the sensor arrangement comes to lie within a desired range.

### BACKGROUND OF THE INVENTION

1. Field of the Invention

The invention relates to a printing-material transport system for a printing machine. Transport systems of this type are employed for conveying a printing material, in particular individual sheets of a printing material, from one printing unit of a multicolor printing machine to the next, for turning or reversing sheets to be printed on both sides, or for depositing finally printed sheets.

As a result of the fast operating cycles of modern printing machines, transport systems of this type must be capable of transporting the printing material at speeds of several tens of km/h, without smearing freshly printed ink in the process. In order to protect the ink, it is desirable to hold the printing material with grippers at most at edges thereof, but otherwise to be able to transport it virtually without contact. Transport systems have therefore been developed wherein the printing material is transported along a guide surface and, between the guide surface and the printing material, an air cushion is produced which is intended to prevent contact between the two. This is not always reliably successful. If the printing material has only a slight stiffness, it tends to flutter during rapid transport, and in this way can come into contact with the guide surface. If the printing material has a great stiffness, this can lead to contact with the guide surface at curved locations on the transport path.

Because the behavior of the transported printing material depends not only upon the stiffness thereof but also upon the transport speed, and also upon the format in the case of a sheet-like printing material, it is extremely complicated to determine values for the thickness of the air cushion which, under all conceivable conditions of use, ensure satisfactory protection against smearing.

2. Summary of the Invention

It is an object of the invention to provide a printed-material transport system which, according to the illustrated embodiment, is for a printing machine having at least one printing-material guide surface and a device for producing an air cushion between the guide surface and the printing material, the transport system having at least one sensor arrangement for registering a spaced distance between the printing material and the guide surface, and a control device for controlling/regulating the thickness of the air cushion, based upon the registered distance, so that the spaced distance registered by the sensor comes to lie within a desired or nominal range. The transport system thus provided in accordance with the invention is much improved over heretofore known transport systems of this general type.

With the foregoing and other objects in view, there is provided, in accordance with the invention, a printing-material transport system for a printing machine, having at least one printing-material guide surface and a device for producing an air cushion between the guide surface and the printing material, comprising at least one sensor arrangement for registering the spaced distance between the printing material and the guide surface, and a control device for controlling the thickness of the air cushion, based upon the registered distance, so that the spaced distance registered by the sensor arrangement comes to lie within a desired range.

In accordance with another feature of the invention, the device for producing the air cushion has a pressure source, and air outlet openings are arranged on the guide surface and are connected to the pressure source.

In accordance with a further feature of the invention, the sensor arrangement includes a sensor arranged on the guide surface.

In accordance with an added feature if the invention, the sensor is a capacitive sensor.

In accordance with an additional feature of the invention, the sensor is constructed of metallic and insulating films.

In accordance with yet another feature of the invention, the sensor has, in a planar arrangement, a measuring electrode and a shielding electrode surrounding the measuring electrode and insulated therefrom.

In accordance with yet a further feature of the invention, the sensor arrangement has a control circuit for applying a first alternating voltage signal to the measuring electrode and for registering the reactance of a capacitor formed from the measuring electrode and the printing material located opposite the measuring electrode.

In accordance with yet an added feature of the invention, the control circuit serves for applying a second alternating voltage signal to the shielding electrode and for regulating the amplitude thereof so that the electric field of the measuring electrode is at least approximately perpendicular thereto.

In accordance with yet an additional feature of the invention, the sensor arrangement includes a timer circuit for receiving a synchronization signal coupled with the operating cycle of the printing machine and ensuring that the distance between the printing material and the guide surface is registered only during part of each cycle of the printing machine.

In accordance with a concomitant feature of the invention, the printing-material transport system includes gripper bars for pulling the printing material along the guide surface, the timer circuit serving to suppress the registration of the distance between the printing material and the guide surface when a gripper bar is in the vicinity of the sensor.

The device for producing the air cushion is generally an excess pressure source and air outlet openings arranged on the guide surface and connected to the excess pressure source. The guide surface can be planar in the form of metal sheets, plates and the like, the guide surface having blown-air and/or suction openings formed therein for pneumatically regulating or controlling therefrom the spaced distance of a sheet disposed adjacent thereto. The air cushion or supporting air pad can be provided likewise between brackets, pipes or the like, the surfaces, which are narrow in relation to the sheet surface, being a constituent part of the aforementioned guide surface.

The sensor used as a spacer sensor between the guide surface and printing material is any desired sensor, for example, operating in accordance with optical or pneumatic principles, which acts from the side of the supporting air pad.

The sensor arrangement preferably includes a sensor arranged on the guide surface itself. Such a sensor should be as small as possible, in particular as flat as possible, so that it can be arranged on the guide surface without disrupting the printing-material transport. These requirements can be met particularly well by a capacitive sensor. Such a sensor can be formed from thin metallic and insulating films or foils adhesively bonded onto the guide surface.

The sensor preferably has, in a planar arrangement, a measuring electrode and a shielding electrode surrounding the measuring electrode and insulated therefrom. These electrodes can each have alternating voltage signals applied thereto by a control circuit, the phase and amplitude of the two alternating voltage signals being regulated relative to one another by the control circuit so that the electric field of the measuring electrode is virtually perpendicular to the measuring electrode, up to a typical measurement distance. This ensures a strength of electric field which remains virtually constant from the measuring electrode to as far as the measurement location and, consequently, a linear characteristic of the sensor.

In transport systems for sheet-printing machines, use is conventionally made of gripper bars which extend virtually over the width of the printing machine, hold a sheet to be conveyed, at the leading edge thereof, and pull the sheet behind the respective gripper bar. In order to prevent the gripper bars from also being registered during the registration of the spaced distance of the sheet and, as a result, falsifying the result of the registration, a timer circuit is preferably provided which receives a synchronization signal coupled to the operating cycle of the printing machine and ensures that the distance is not registered when a gripper bar is located in the detection area of the sensor.

Other features which are considered as characteristic for the invention are set forth in the appended claims.

Although the invention is illustrated and described herein as embodied in a transport system for a printing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary diagrammatic side elevational view of a last printing unit and the delivery of a first-form and perfecter or recto/verso printing machine, on the one hand, or a single-side or recto printing machine, on the other hand; and

FIG. 2 is an enlarged fragmentary view of FIG. 1.

### DESCRIPTION OF THE PREFERRED EMBODIMENTS

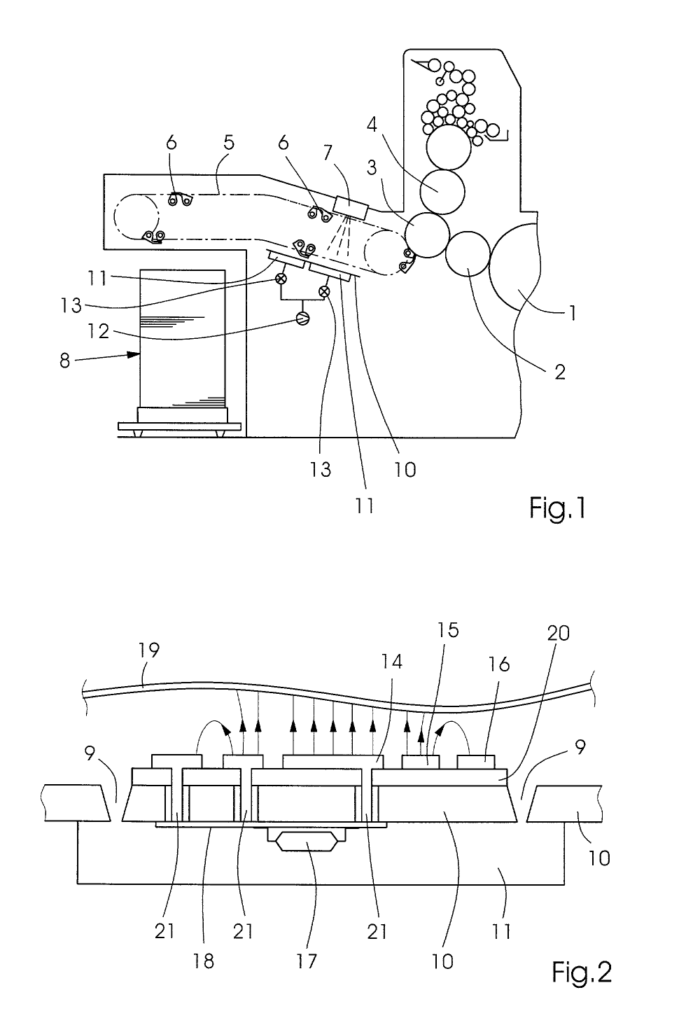

The construction of the printing unit of FIG. 1 is generally known and does not have to be described in detail. Transfer drums 1 and 2 accept a sheet to be printed from a printing unit arranged upline and transfer it to an impression cylinder 3. On the latter, the sheet passes through a nip between the impression cylinder 3 and a blanket cylinder 4, wherein it is printed, and then transferred to a transport system which comprises a plurality of gripper bars 6 guided on endless chains 5. In FIG. 1, the chains 5 revolve in a clockwise direction and transport printed sheets, respectively, suspended on the underside thereof, to a delivery pile 8. A dryer 7 operating with infra-red IR or ultraviolet UV radiation is arranged on the transport system so that the radiation therefrom falls on the last-printed, top side of each sheet.

In order to ensure an exact and uniform guidance of each sheet on the transport system, a printing-material guide surface 10 in the form of a metal sheet fitted with nozzles is arranged on the lower run of chains 5, and prevents the uncontrolled downward deposition of a sheet. Perforations (not visible in FIG. 1) of the guide surface 10, forming nozzles, open on compressed-air boxes 11, of which there are two in the system shown in FIG. 1. The boxes 11 are supplied with compressed air by a pump 12 via setting or adjusting valves 13. The extent of opening of the setting valves 13 can be regulated by an electronic control circuit, which is not illustrated in FIG. 1 and the mode of operation of which is discussed in greater detail hereinafter.

FIG. 2 shows in detail a part of the guide surface 11. The guide surface 11 comprises a flat metal sheet with perforations 9 (transport nozzles) formed therein, which open onto a compressed-air box 11 mounted under the guide surface 11.

Applied between the two perforations 9 illustrated in FIG. 2, on the guide surface 10, is an insulating plastic film 20 a few micrometers thick, which bears three concentric electrodes 14, 15 and 16 which are insulated from one another and are formed from a metal foil or film. The innermost electrode 14 of the three electrodes constitutes a measuring electrode, and is, respectively, surrounded annularly by a shielding electrode 15 and a ground electrode 16. In addition to a concentric and annular construction, respectively, of the electrodes 14, 15 and 16, electrodes having other forms, such as rectangular forms, can also be employed. The thickness of the electrodes is only a few micrometers. The three electrodes are respectively connected, via pressure contacts 21 insulated from the guide surface 10, to outputs of a control circuit 17, which is mounted on a circuit board 18 on the underside of the guide surface 10, inside the compressed-air box 11.

A printing-material sheet 19 drawn over the guide surface 10 by gripper bars forms, together with the measuring electrode 14, a capacitor having a capacitance which depends upon the distance between the sheet 19 and the measuring electrode 14. In the case of an ideal plate capacitor, this relationship is given by the formula

C=εε₀A/d

wherein A is the surface of the capacitor plates and d designates the spacing thereof.

In order to attain the situation wherein this simple relationship also applies to the capacitor present here, it is necessary for the induced electric field between the measuring electrode 14 and the sheet 19, induced by applying an electric voltage to the measuring electrode 14, to be similar to that of an ideal plate capacitor, i.e., it must be at least approximately parallel and disposed at least approximately perpendicularly on the surface of the measuring electrode 14. In order to achieve this, the shielding electrode 15 is provided. The two electrodes, respectively, have two alternating voltage signals applied thereto by the control circuit 17, the signals being virtually identical in terms of amplitude and phase. The result thereof is that, in the case of a real plate capacitor, the unavoidable fact that the field lines run out at the edge of the plates onto the field of the shielding electrode 12 remains restricted, while the field lines originating from the measuring electrode 14 extend virtually parallel as far as the sheet 19.

The ground electrode 16 which is illustrated in FIG. 2 and surrounds the shielding electrode 15 annularly can also be omitted if, in place thereof, the electrically conductive guide surface 10 is kept at ground potential.

The control circuit generates a first alternating voltage signal by impressing an alternating current with prescribed strength and frequency on the measuring electrode 14. The voltage amplitude of this signal is established in proportion with the reactance Xc of the plate capacitor.

$$\begin{matrix}{X}_{c} = \frac{1}{i ω C} \\ = \frac{1}{i ω {ϵ}_{0} {ϵ}_{R}} \frac{d}{A} ,\end{matrix}$$

wherein, here, A is the area of the measuring electrode 14.

A second alternating voltage signal, which is applied to the shielding electrode 15, is generated from the first alternating voltage signal by the control circuit 17 with the aid of a voltage follower.

In the control circuit 17, the measured alternating voltage amplitude is compared with a limiting value. What is significant is that if the measured value should fall below the limit, the sheet 19 then has come closer to the guide surface 10 than permitted. In such a case, under the control of the control circuit 17, the output of the pump or the extent of opening of the valve 13 supplying the respective compressed-air box is increased in order to reinforce the air cushion formed by the compressed air emerging from the perforations 9, between the guide surface 10 and the sheet 19 and in this way to move the latter to a greater distance. Conversely, the thickness of the air cushion is reduced if the measured distance exceeds a second limiting value.

Provision can preferably be made for the arrangement to be constructed as a two-point regulator system, i.e., the measured value is compared with a limiting value. If the limiting value is reached or exceeded, then the air cushion is correspondingly reinforced or reduced. Alternatively, it is also possible to perform the operation by a regulator with a prescribed desired or nominal value. This constitutes a particularly valuable solution. The desired or nominal value prescribed is the distance X of the sheets 19 from the guide surface 10. The deviation from the desired-value position is determined as ±ΔX. The actuator of the regulator is preferably adjusted in proportion to the deviation ±ΔX.

Alternatively, the control circuit 17 can impress an alternating voltage with a prescribed frequency and amplitude, and measure the strength of the resulting alternating current.

The critical factor for the registration is that there must be values of the voltage and current strength, either prescribed or measured, which permit conclusions to be drawn about the reactance of the capacitor.

With the capacitive measuring principle of the sensor arrangement from FIG. 2, measured distance values with a frequency in the kilohertz range can be obtained. This permits hundreds of measured values to be picked up during the passage of a single sheet in front of the sensor, and this permits a rapid fluttering movement of the sheet 19 to be detected.

Because the sensor from FIG. 2 is essentially constructed only from two layers of thin films, and therefore has a thickness in the range of fractions of a millimeter, it has no noticeable influence on the air flow relationships between the guide surface and a sheet transported over the latter. Such a sensor arrangement can therefore also be retrofitted without difficulty into already existing transport systems for printing machines.

As a consequence of a preferred refinement of the invention, the control circuit 17 is coupled to a rotary encoder, which can be mounted on any desired drum in the printing machine which is synchronized with the machine cycle rate, and supplies the control circuit 17 with a synchronization signal.

This makes it possible for the control circuit 17 always to suppress the pickup of measured distance values when a gripper bar is passing the sensor, which would falsify the measurement results. In the same way, the pickup of measured values can be suppressed when there is currently no sheet 19 in front of the sensor. For this purpose, it is necessary for the control circuit 17, in addition to the synchronization signal, to receive information about the length of the sheets being processed at that time. This suppression of the pickup of measured values from time to time makes the subsequent processing of the measured values easier; in particular, the formation of a characteristic value, for example low-pass filtering, can be obtained from the conclusion relating to the average distance between printing-material sheet and guide surface.

Sensor arrangements of the type described with reference to FIG. 2 can be provided at various locations in a transport system of a printing machine, in order to regulate the thickness of the air cushion locally thereat, respectively. They can be used not only in the delivery, as illustrated in FIG. 1, but also during the transport of the printing material between two printing units of a machine, or in the sheet turning or reversing device of a printing machine.

I claim:

1. A printing-material transport system for a printing machine, having at least one printing-material guide surface and a device for producing an air cushion between the guide surface and the printing material, comprising at least one sensor arrangement for registering the spaced distance between the printing material and the guide surface, and a control device for controlling the thickness of the air cushion, based upon the registered distance, so that the spaced distance registered by the sensor arrangement comes to lie within a desired range.

2. The printing-material transport system according to claim 1, wherein the device for producing the air cushion has a pressure source, and air outlet openings are arranged on the guide surface and are connected to said pressure source.

3. The printing-material transport system according to claim 1, wherein said sensor arrangement includes a sensor arranged on the guide surface.

4. The printing-material transport system according to claim 3, wherein said sensor is a capacitive sensor.

5. The printing-material transport system according to claim 4, wherein said sensor is constructed of metallic and insulating films.

6. The printing-material transport system according to claim 4, wherein said sensor has, in a planar arrangement, a measuring electrode and a shielding electrode surrounding the measuring electrode and insulated therefrom.

7. The printing-material transport system according to claim 6, wherein the sensor arrangement has a control circuit for applying a first alternating voltage signal to the measuring electrode and for registering the reactance of a capacitor formed from the measuring electrode and the printing material located opposite the measuring electrode.

8. The printing-material transport system according to claim 7, wherein said control circuit serves for applying a second alternating voltage signal to the shielding electrode and for regulating the amplitude thereof so that the electric field of the measuring electrode is at least approximately perpendicular thereto.

9. The printing-material transport system according to claim 1, wherein the sensor arrangement includes a timer circuit for receiving a synchronization signal coupled with the operating cycle of the printing machine and ensuring that the distance between the printing material and the guide surface is registered only during part of each cycle of the printing machine.

10. The printing-material transport system according to claim 9, including gripper bars for pulling the printing material along the guide surface, said timer circuit serving to suppress the registration of the distance between the printing material and the guide surface when a gripper bar is in the vicinity of the sensor.
